(19) United States
(12) Patent Application Publication
(10) Pub. No.: US 2026/0283437 A1
(43) Pub. Date: Sep. 24, 2026

(54) ROBOT CLEANER STATION

(71) Applicant: LG ELECTRONICS INC., Seoul (KR)

(72) Inventors: Kyoungho RYOU, Seoul (KR); Jungwan RYU, Seoul (KR); Eungjin AHN, Seoul (KR); Jeonguk CHA, Seoul (KR)

(73) Assignee: LG ELECTRONICS INC., Seoul (KR)

(21) Appl. No.: 19/572,296

(22) Filed: Mar. 19, 2026

(30) Foreign Application Priority Data
Mar. 19, 2025 (KR) 10-2025-0035160

(51) Int. Cl. A47L 11/40; A47L 9/00

(52) U.S. Cl. CPC A47L 11/4091; A47L 9/0063; A47L 2201/02

(57) ABSTRACT

The present disclosure relates to a robot cleaner station, and includes a docking sensor unit configured to transmit and receive a signal to and from a robot cleaner. The docking sensor unit includes a first sensor and a second sensor. The first sensor is operated in a state where a door unit is closed, and the second sensor is operated in a state where the door unit is opened, thereby providing an effect of accurately and precisely aligning a position of the robot cleaner.

This application claims priority to and the benefit of Korean Patent Application No. 10-2025-0035160, filed on Mar. 19, 2025, the disclosure of which is incorporated herein by reference in its entirety.

### BACKGROUND

### Technical Field

Embodiments of the present disclosure relate to a robot cleaner station, and more particularly, to a robot cleaner station configured to, when a robot cleaner is coupled thereto, collect dust from a dust bin of the robot cleaner, wash a mop of the robot cleaner, and dry the mop, wherein the robot cleaner station is configured in a drawer type to store items and provide an aesthetic appearance.

### Background of the Disclosure

Recently, with the development of industrial technology, robot cleaners have been developed that travel and perform cleaning in a required area by themselves without a user's operation.

Such a robot cleaner includes a sensor capable of recognizing a space to be cleaned, an agitator capable of sweeping and cleaning a floor surface, and a mop capable of wiping the floor surface, and is configured to travel while suctioning dust from the floor surface recognized by the sensor and wiping the floor surface with the mop or the like.

Among robot cleaners, there are dry robot cleaners capable of suctioning and removing foreign substances scattered on a floor surface and wet robot cleaners capable of wiping the floor surface with a mop containing moisture to effectively remove foreign substances attached to the floor surface. The dry robot cleaner includes a dust bin and suctions foreign substances on the floor surface by a suction force of a suction motor. The wet robot cleaner includes a water tank and is configured to effectively remove foreign substances attached to the floor surface by supplying water contained in the water tank to the mop so that the mop wipes the floor surface in a state of containing moisture. Further, there is also a robot cleaner provided with both an agitator and a mop.

A charging dock of the robot cleaner is a device to which the robot cleaner that has finished cleaning is docked, and which supplies power to a battery provided in the robot cleaner to charge the battery. The charging dock includes a power supply module therein. The charging dock includes a charging terminal connected to the power supply module, and the robot cleaner includes a corresponding terminal. When the charging terminal and the corresponding terminal come into contact, power is supplied to the battery to be charged.

Meanwhile, when the charging dock of the robot cleaner is disposed inside a building, it occupies a certain range of an indoor space. In this case, the space efficiency of the interior may deteriorate. Furthermore, while a user or a pet passes by, the user or the pet may collide with the robot cleaner, which may lead to not only injuries to the user or the pet but also damage to the robot cleaner.

In addition, in the case of a station to which a dust collection function of the robot cleaner is added, there is a limitation that the interior design of the room may be spoiled as an occupied volume increases.

Meanwhile, Chinese Utility Model Registration CN 216167233 U discloses a robot cleaner station that includes a plurality of water tanks coupled to be extractable in a drawer type, and to which a robot cleaner is coupled at a lower side to wash a wet mop of the robot cleaner.

However, in the aforementioned robot cleaner station, an open space without a door is formed in a chamber into which the robot cleaner is inserted, and a flow path is also configured to be detached when the water tank is detached.

Since the space where the robot cleaner is seated is open, the aesthetic appearance is degraded, and there is a risk that the robot cleaner may be damaged or malfunction due to a collision between the robot cleaner and another object.

In addition, the aforementioned robot cleaner station is formed in a structure in which the flow path is also detached when the water tank is detached, so that when the water tank is detached, leakage occurs inside the robot cleaner station, and there is a problem that contamination or odor occurs due to the leakage.

In this regard, Chinese Patent Application Publication CN 116889354 A discloses a robot cleaner station in which a robot cleaner is seated inside the robot cleaner station and a door is closed to prevent the robot cleaner from being exposed to the outside.

However, in the robot cleaner station, a docking unit is separated from a dust collection hole in a state where a drawer member is extracted, and the docking unit is docked with the dust collection hole in a state where the drawer member is inserted.

In addition, in the robot cleaner station, when dust is collected in a dust collection unit, the drawer member must be extracted to remove the dust. That is, since the dust collection hole and the docking unit are separated in the state where the drawer member is extracted, dust remaining in the dust collection hole and the docking unit may leak into the robot cleaner station.

Accordingly, the robot cleaner station has a problem of poor hygiene due to the leakage of dust and causing a malfunction of an internal configuration of the robot cleaner station.

In addition, although the robot cleaner station includes a position sensor, there is no disclosure of a sensor that transmits and receives a signal to and from the robot cleaner when the door is opened or closed while not being exposed to the outside.

### SUMMARY

The present disclosure has been devised to improve the problems of the conventional robot cleaner stations as described above, and an object of the present disclosure is to provide a robot cleaner station capable of storing items.

Another object of the present disclosure is to provide a robot cleaner station capable of providing an aesthetic appearance as an interior design of a room.

Still another object of the present disclosure is to provide a robot cleaner station that includes a plurality of sensors to accurately and precisely align a position of a robot cleaner when the robot cleaner docks with the robot cleaner station.

Still another object of the present disclosure is to provide a robot cleaner station capable of preventing a collision with the robot cleaner station during a docking process of the robot cleaner.

Still another object of the present disclosure is to provide a robot cleaner station that includes a voice recognition module so that a user can control an operation of the robot cleaner station 100 by voice.

In order to achieve the above objects, a robot cleaner station according to the present disclosure may include: a housing; a base disposed in the housing, wherein at least a portion of a robot cleaner is seated on the base; a door unit configured to open and close an entrance through which the robot cleaner enters and exits the base; and a docking sensor unit configured to transmit and receive a signal to and from the robot cleaner.

The docking sensor unit may include a first sensor and a second sensor, and the first sensor may be operated in a state where the door unit is closed, and the second sensor may be operated in a state where the door unit is opened.

At this time, the first sensor may be positioned closer to the ground than the second sensor and may be coupled to a lower surface of the housing.

The second sensor may be positioned at an upper side of a bottom surface of the housing.

The first sensor may be exposed in the state where the door unit is closed, and the second sensor may be exposed in the state where the door unit is opened.

The first sensor may include a first front sensor and a first side sensor, and a sensor transmitting and receiving the signal to and from the robot cleaner may be selectively changed between the first front sensor and the first side sensor according to a position of the robot cleaner.

The first front sensor may be positioned at a lower side of the entrance and positioned at a front end of the bottom surface of the housing.

The first side sensor may be positioned more rearward than the first front sensor and positioned at lateral ends of the housing.

The docking sensor unit may further include a voice recognition module.

As described above, according to the robot cleaner station of the present disclosure, an upper surface of a housing may be used like a shelf, and a drawer and a storage unit are provided on a front surface of the housing, so that items can be stored like a chest of drawers.

In addition, when a robot cleaner enters inside the housing, the robot cleaner is not exposed to the outside and a docking sensor unit is also not exposed to the outside, thereby providing an aesthetic appearance like indoor furniture.

In addition, there is an effect that a position of the robot cleaner can be accurately and precisely aligned when the robot cleaner docks with the robot cleaner station by providing a plurality of sensors.

In addition, the plurality of sensors selectively transmit and receive a signal to and from the robot cleaner, thereby preventing a collision with the robot cleaner station during a docking process of the robot cleaner and guiding a docking path.

In addition, by providing a voice recognition module, a user may control an operation of the robot cleaner station 100 by voice, thereby increasing user convenience.

### BRIEF DESCRIPTION OF THE DRAWINGS

FIG. 1 is a perspective view for explaining a robot cleaner station according to an embodiment of the present disclosure.

FIG. 2 is a front view of the robot cleaner station of FIG. 1.

FIG. 3 is a rear view of the robot cleaner station of FIG. 1.

FIG. 4 is a cross-sectional view of the robot cleaner station of FIG. 1.

FIG. 5 is a perspective view for explaining a robot cleaner according to an embodiment of the present disclosure.

FIG. 6 is a side view of the robot cleaner of FIG. 5.

FIG. 7 is a bottom view of the robot cleaner of FIG. 5.

FIG. 8 is a rear view of the robot cleaner of FIG. 5.

FIG. 9 is a perspective view for explaining a state in which a door is opened in the robot cleaner station according to an embodiment of the present disclosure.

FIG. 10 is an enlarged view of FIG. 4.

FIG. 11 is a front view of FIG. 9.

FIG. 12 is a view for explaining a seating part in the robot cleaner station according to an embodiment of the present disclosure.

FIG. 13 is a perspective view for explaining a direction in which a dust bag and a detergent tank are extracted in the robot cleaner station according to an embodiment of the present disclosure.

FIG. 14 is a perspective view for explaining that a drawer is extracted in the robot cleaner station according to an embodiment of the present disclosure.

FIG. 15 is a bottom view of FIG. 1.

FIG. 16 is a perspective view for explaining a docking sensor unit of the robot cleaner station according to an embodiment of the present disclosure.

FIG. 17 is a perspective view of a first front sensor according to an embodiment of the present disclosure.

FIG. 18 is a perspective view of a first side sensor according to an embodiment of the present disclosure.

FIG. 19 is a perspective view of a second sensor according to an embodiment of the present disclosure.

### DETAILED DESCRIPTION OF SPECIFIC EMBODIMENTS

Hereinafter, preferred embodiments of the present disclosure will be described in detail with reference to the accompanying drawings.

Since the present disclosure may have various changes and may have various embodiments, specific embodiments will be illustrated in the drawings and described in detail in the detailed description. This is not intended to limit the present disclosure to specific embodiments, and should be understood to include all changes, equivalents, or substitutes included in the spirit and technical scope of the present disclosure.

In describing the present disclosure, terms such as "first" and "second" may be used to describe various components, but the components may not be limited by the terms. The terms are used only for the purpose of distinguishing one component from another component. For example, a first component may be named a second component without departing from the scope of the present disclosure, and similarly, a second component may also be named a first component.

The term "and/or" may include a combination of a plurality of related listed items or any item among the plurality of related listed items.

When a component is referred to as being "connected" or "coupled" to another component, it should be understood that it may be directly connected or coupled to the other component, but another component may exist in between. On the other hand, when a component is referred to as being "directly connected" or "directly coupled" to another component, it should be understood that no other component exists in between.

The terminology used in the present application is used only to describe specific embodiments and is not intended to limit the present disclosure. A singular expression may include a plural expression unless the context clearly indicates otherwise.

In the present application, terms such as "comprise" or "include" are intended to designate that a feature, a number, a step, an operation, a component, a part, or a combination thereof described in the specification exists, and it should be understood that it does not pre-exclude the possibility of existence or addition of one or more other features, numbers, steps, operations, components, parts, or combinations thereof.

Unless otherwise defined, all terms used herein, including technical or scientific terms, may have the same meaning as generally understood by those of ordinary skill in the art to which the present disclosure belongs. Terms such as those defined in generally used dictionaries may be interpreted as having a meaning consistent with the meaning in the context of the related technology, and unless explicitly defined in the present application, they may not be interpreted in an ideal or excessively formal sense.

In addition, the following embodiments are provided to more completely explain to those with average knowledge in the art, and the shapes and sizes of elements in the drawings may be exaggerated for a clearer explanation.

### Cleaner System

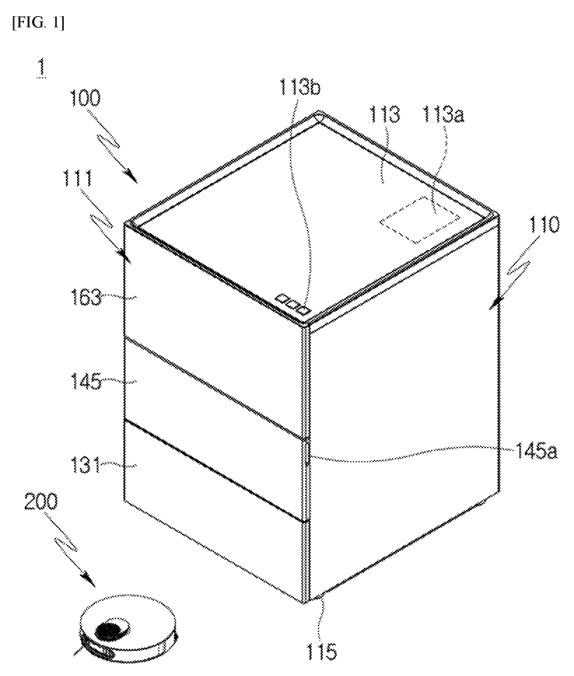

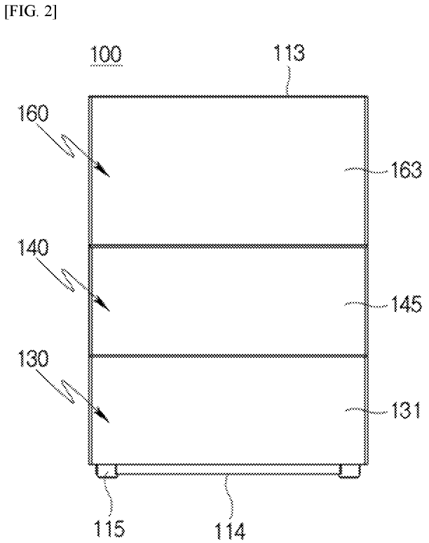

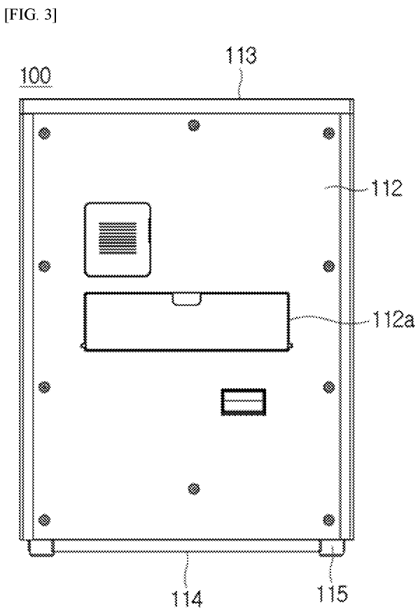

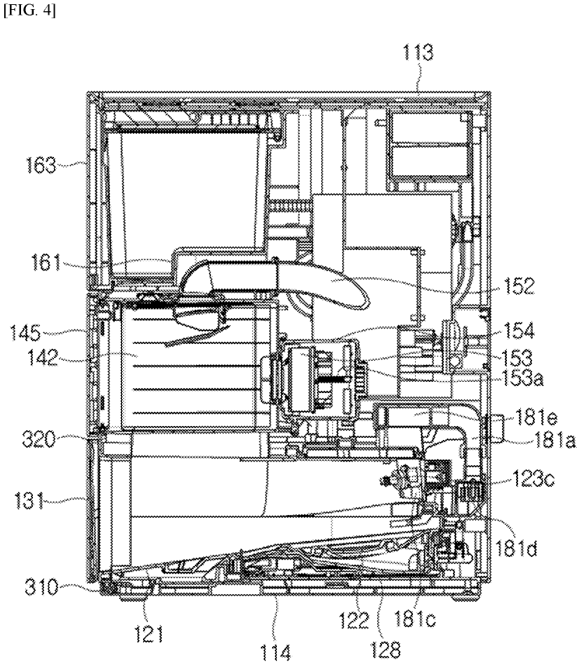

FIG. 1 is a view for explaining a cleaner system according to an embodiment of the present disclosure, FIG. 2 is a front view of FIGS. 1 and 3, is a rear view of FIGS. 1 and 4 is a cross-sectional view of FIG. 1.

Referring to FIGS. 1 to 4, a cleaner system 1 according to an embodiment of the present disclosure includes a robot cleaner station 100 and a robot cleaner 200.

The robot cleaner 200 may be seated in the robot cleaner station 100. Specifically, the robot cleaner 200 may enter into a front surface of the robot cleaner station 100, and the robot cleaner 200 may be accommodated inside the robot cleaner station 100.

When the robot cleaner 200 enters inside the robot cleaner station 100, it may be seated on a base 121 of the robot cleaner station 100. In this case, the robot cleaner 200 and the robot cleaner station 100 may be electrically and fluidly docked. Specifically, a dust bin 220 of the robot cleaner 200 may be fluidly connected to a dust collection unit 150 of the robot cleaner station 100. Further, a water tank 230 of the robot cleaner 200 may be connected to a water supply nozzle 123c of the robot cleaner station 100. Further, a charging terminal 280 of the robot cleaner 200 may be electrically connected to a power supply terminal 123b of the robot cleaner station 100.

Accordingly, the robot cleaner station 100 may remove dust from the dust bin 220 of the robot cleaner 200. The robot cleaner station 100 may wash a mop 242 of the robot cleaner 200. The robot cleaner station 100 may dry the mop 242 of the robot cleaner 200. The robot cleaner station 100 may supply power to the robot cleaner 200.

### Robot Cleaner

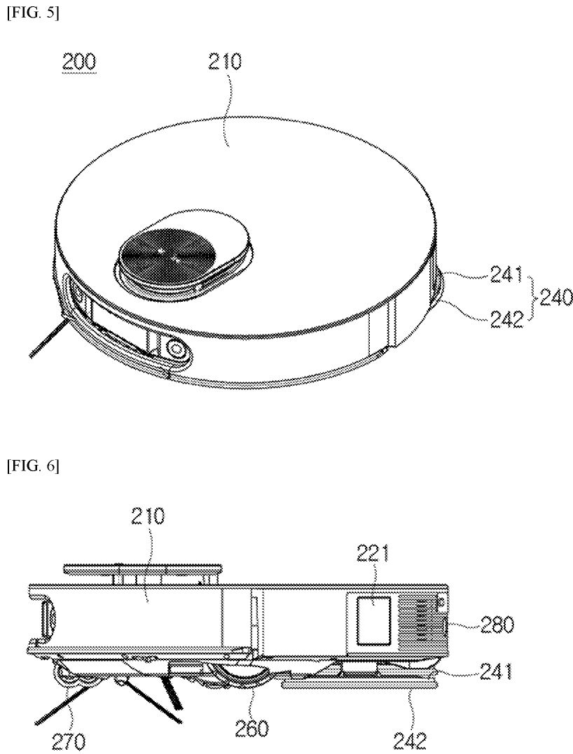

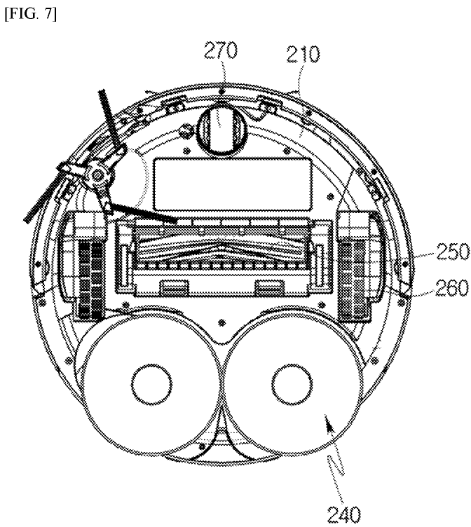

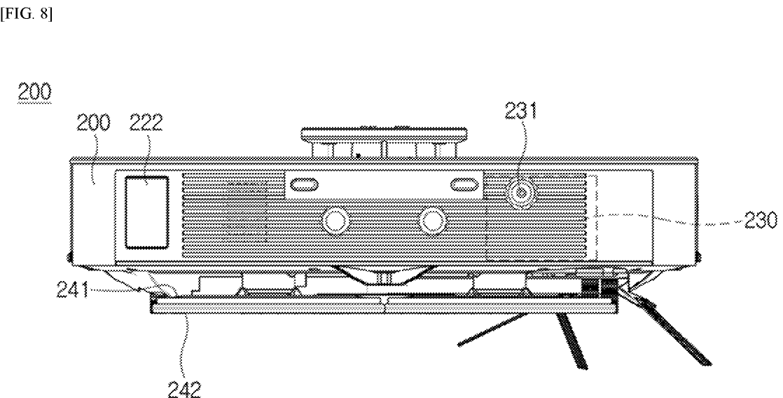

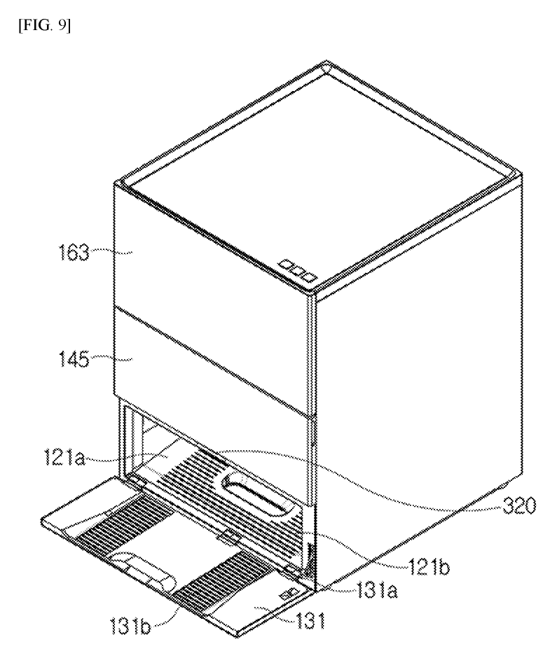

FIG. 5 is a perspective view for explaining a robot cleaner according to an embodiment of the present disclosure, FIG. 6 is a side view of FIGS. 5, 7 is a bottom view of FIGS. 5, and 8 is a rear view of FIG. 5.

The structure of the robot cleaner 200 will be described with reference to FIGS. 5 to 8 as follows.

The robot cleaner 200 may automatically clean a required area by traveling through the area to be cleaned by itself and suctioning foreign substances such as dust from a floor.

The robot cleaner 200 according to the embodiment of the present disclosure is configured to be placed on the floor and clean the floor while moving along the floor surface. Accordingly, hereinafter, the vertical direction (upward and downward directions) will be determined and described based on a state in which the robot cleaner 200 is placed on the floor.

Further, based on a pair of wheels 260, a side where an auxiliary wheel 270, which will be described later, is disposed is defined as a front side, and a side where a rotary cleaning unit 240, which will be described later, is disposed is defined as a rear side.

The "lowest portion" of each component described in the embodiment of the present disclosure may be a portion positioned lowest in each component or a portion closest to the floor when the robot cleaner 200 according to the embodiment of the present disclosure is placed on the floor and used.

The robot cleaner 200 according to the embodiment of the present disclosure includes a body 210, a dust bin 220, a water tank 230, a rotary cleaning unit 240, an agitator 250, wheels 260, an auxiliary wheel 270, and a charging terminal 280.

The body 210 may form the overall appearance of the robot cleaner 200. Each component of the robot cleaner 200 may be coupled to the body 210, and some components of the robot cleaner 200 may be accommodated inside the body 210.

Specifically, components of the robot cleaner 200 may be provided in an internal space of the body 210. For example, the body 210 may accommodate a battery and at least one motor in the internal space.

In the embodiment of the present disclosure, the body 210 may be formed in a shape in which a width (or diameter) in a horizontal direction is larger than a height in the vertical direction. Such a body 210 may help the robot cleaner 200 to form a stable structure and provide a structure advantageous for avoiding an obstacle when the robot cleaner 200 moves (travels).

When viewed from above or below, the body 210 may be formed in various shapes such as a circle, an oval, or a rectangle.

The body 210 may be divided into a lower body and an upper body, and the lower body and the upper body may be coupled to form a space therein.

The lower body may be coupled with the upper body to form a space capable of accommodating the battery, at least one sensor, and at least one motor therein.

The lower body may include a suction port 211 through which air is introduced and a hole accommodating the pair of wheels 260.

The suction port 211 may be a passage through which dust on the floor surface is introduced. Further, the suction port 211 may communicate with a suction flow path (not shown) formed inside the body 210, and the suction flow path may communicate with the internal space of the dust bin 220.

Meanwhile, the lower body may further include an exhaust flow path. One side of the exhaust flow path communicates with the internal space of the dust bin 220, and the other side communicates with an exhaust port. At this time, a filter may be disposed at the exhaust port.

With such a configuration, air introduced through the suction port 211 flows into the dust bin 220 through the suction flow path and may be discharged to the exhaust port through the exhaust flow path.

The agitator 250, which will be described later, may be rotatably accommodated in the suction port 211. With such a configuration, dust around the suction port 211 may be guided into the suction port 211 by the rotation of the agitator 250, and the efficiency of suctioning dust may be increased.

The upper body may form the upper appearance of the robot cleaner 200. Although not shown, a display may be provided on the upper body.

The robot cleaner 200 of the present disclosure may include a bumper. The bumper is coupled along the rim of the body 210 and is configured to move relative to the body 210.

The bumper may be coupled along a portion of the rim of the body 210 or may be coupled along the entire rim of the body 210. At least one elastic member (not shown) may be provided between the bumper and the body 210. With such a configuration, when the bumper comes into contact with an obstacle or the like and relatively moves toward the center of the body 210, the bumper may return to its original position by the restoring force of the elastic member (not shown), and may prevent or reduce the transfer of an impact to the body 210 by absorbing or dispersing the impact applied to the bumper.

The dust bin 220 may be provided to suction external dust and air and store the dust.

The dust bin 220 may store dust introduced through the suction flow path. The dust bin 220 may include a dust inlet communicating with the suction flow path, an internal space capable of storing the dust, and an air outlet through which air can be discharged.

The dust bin 220 may be provided inside the body 210. At this time, the dust bin 220 may be fixedly coupled to the body 210 or may be detachably provided according to the embodiment.

Meanwhile, in the present disclosure, a dust discharge flow path may be formed in the dust bin 220. The dust discharge flow path may communicate the internal space of the dust bin 220 with the external space of the robot cleaner 200. With such a configuration, when dust is collected through the robot cleaner station 100, the dust inside the dust bin 220 may be removed.

Meanwhile, a dust discharge port 221 communicating with the dust discharge flow path may be formed in the dust bin 220 according to the embodiment of the present disclosure. For example, the dust discharge port 221 may be formed at one side of the rear of the outer surface (or outer circumferential surface) of the body 210. As another example, the dust discharge port 221 may be formed on the outer surface of the dust bin 220.

Further, the robot cleaner 200 according to the embodiment of the present disclosure may be provided with a dust bin door 222 capable of selectively opening and closing the dust discharge port 221. Specifically, the dust bin door 222 is coupled to the body 210 and may be disposed at a position capable of blocking the dust discharge port 221. For example, the dust bin door 222 is formed of a rubber or resin material and is flippably provided, so that one side thereof may be fixedly coupled to the body 210.

With such a configuration, when a dust collection motor 153 of the robot cleaner station 100, which will be described later, is operated, the dust bin door 222 is elastically deformed by the driving force of the dust collection motor 153, and as the dust discharge port 221 is opened, the dust in the dust bin 220 may be collected into the dust collection unit 150 of the robot cleaner station 100.

The water tank 230 is formed in a shape of a container having an internal space so that a liquid such as water is stored therein. The water tank 230 is disposed inside the body 210, and may be fixedly coupled to the body 210 or may be detachably coupled to the body 210.

The water tank 230 includes a supply part 231 and a nozzle (not shown). The supply part 231 may be provided so that a liquid such as water is supplied from the outside. For example, the supply part 231 includes an injection port formed at the other side of the rear of the outer surface (or outer circumferential surface) of the body 210, and may be connected to the storage space inside the water tank 230 through a water supply hose.

At this time, the supply part 231 may be disposed on the opposite side in the lateral direction of the robot cleaner 200 in a relationship with the dust discharge port 221. For example, if the dust discharge port 221 is disposed at the rear left of the body 210, the supply part 231 may be disposed at the rear right of the body 210.

Through such a configuration, in a state where the robot cleaner 200 is coupled to the robot cleaner station 100, the robot cleaner station 100 can simultaneously perform the collection of dust and the injection of water.

Meanwhile, the nozzle (not shown) is formed in a shape of a tube or a pipe, and is connected to the water tank 230 so that the liquid inside the water tank 230 can flow through the inside thereof. One side of the nozzle (not shown) is connected to the water tank 230, and the other end portion is disposed at the upper side of a pair of rotary plates 241 or respectively positioned at the rotary plates, so that the liquid inside the water tank 230 can be respectively supplied to a pair of mops 242.

That is, the nozzle (not shown) may be formed in a shape in which one pipe is branched into two, and at this time, one of the branched ends may be positioned at the upper side of the left mop, and the other branched end may be positioned at the upper side of the right mop.

Meanwhile, although not shown, the water tank 230 is provided with a pump to flow the water inside the water tank 230 to the nozzle (not shown). Therefore, when the pump of the water tank 230 is operated, the liquid stored in the water tank 230 may be discharged to the rotary cleaning unit 240 through the nozzle (not shown).

The rotary cleaning unit 240 includes the rotary plates 241 and the mops 242.

The rotary plates 241 may be provided as a pair including a left rotary plate and a right rotary plate, and the mops 242 may be provided as a pair including a left mop and a right mop.

The rotary plate 241 may be rotatably disposed on the bottom surface of the body 210, and the mop 242 may be coupled to the lower side thereof.

The rotary plate 241 is formed to have a predetermined area, and is formed in a shape such as a flat plate or a flat frame. Such a rotary plate 241 is generally laid horizontally, and accordingly, is formed in a shape in which a width (or diameter) in the horizontal direction is sufficiently larger than the height in the vertical direction. The rotary plate 241 coupled to the body 210 may be parallel to the floor surface or may form an inclination with the floor surface. The rotary plate 241 may be formed in a circular plate shape, the bottom surface of the rotary plate 241 may generally form a circle, and the rotary plate 241 may be formed in a rotationally symmetrical shape as a whole.

The pair of rotary plates 241 may be symmetrical to each other.

The mop 242 may be coupled to the lower side of the rotary plate 241 so as to face the floor.

The mop 242 is formed so that the bottom surface facing the floor has a predetermined area, and the mop 242 is formed in a flat shape. The mop 242 is formed in a shape in which the width (or diameter) in the horizontal direction is sufficiently larger than the height in the vertical direction. When the mop 242 is coupled to the body 210 side, the bottom surface of the mop 242 may be parallel to the floor or may form an inclination with the floor.

The bottom surface of the mop 242 may generally form a circle, and the mop 242 may be formed in a rotationally symmetrical shape as a whole. Further, the mop 242 may be detachably attached to the bottom surface of the rotary plate 241, and may be coupled to the rotary plate 241 to rotate together with the rotary plate 241.

Meanwhile, although not shown, the rotary cleaning unit 240 may be provided with a driving unit for applying a rotational force to the rotary plate 241. For example, the driving unit may include a motor and at least one gear. Accordingly, when the driving unit is operated, the rotary plate 241 and the mop 242 rotate to wipe and clean the floor surface.

The agitator 250 is provided with a plurality of brushes so as to be rotatable, and can guide external dust and air to the dust bin 220. At this time, it is possible that at least one gear is provided in the agitator 250.

Meanwhile, the agitator 250 according to the present embodiment is provided with a separate agitator motor (not shown) to receive rotational power, and of course, according to the embodiment, it is also possible to receive rotational power from a travel motor, and it is also possible to receive rotational power from the driving unit of the rotary cleaning unit 240.

The wheels 260 may be provided on the bottom surface of the body 210 and may be connected to a driving unit (not shown). At this time, the driving unit (not shown) may be coupled to the body 210.

The wheel 260 is provided on the body 210 and can roll on the floor.

The wheels 260 may include a first travel wheel and a second travel wheel. At this time, the first travel wheel may be formed identically to the second travel wheel or may be formed symmetrically. For example, if the first travel wheel is positioned on the left side of the robot cleaner 200, the second travel wheel may be positioned on the right side of the robot cleaner 200, and at this time, the first travel wheel and the second travel wheel may be symmetrical to each other.

The driving unit (not shown) may include a travel motor and a gear. At this time, the travel motor is accommodated inside the body 210 and can provide power to the wheels 260. The travel motor may include a first travel motor and a second travel motor.

The travel motor may be formed of an electric motor. A plurality of gears are configured to mesh and rotate with each other, connect the travel motor and the wheel 260, and transfer the rotational power of the travel motor to the wheel 260. Accordingly, the wheel 260 can rotate when the rotating shaft of the travel motor rotates.

With such a configuration, when the travel motor is operated, the wheel 260 rotates, and the body 210 can travel at a predetermined travel speed on the floor surface.

The auxiliary wheel 270 is provided on the bottom surface of the body 210 and can roll on the floor surface (surface to be cleaned). The auxiliary wheel 270 can support the body 210 on the floor surface together with the pair of wheels 260. With such a configuration, the auxiliary wheel 270 can guide the movement of the robot cleaner 200 while minimizing friction between the robot cleaner 200 and the floor surface.

A suction motor (not shown) can generate a suction force capable of suctioning external dust and air through the suction port 211. For example, the suction motor (not shown) may be an electric motor. External dust and air may be introduced into the suction port 211 by the suction force generated by the suction motor (not shown), and after passing through the suction flow path, it can reach the dust bin 220.

Although not shown, the battery is coupled to the body 210 and is configured to supply power to other components constituting the robot cleaner 200. The battery can supply power to at least one motor provided in the robot cleaner 200. For example, the battery can supply power to motors provided in the rotary cleaning unit 240, the agitator 250, the wheels 260, and the suction motor (not shown).

Further, the battery can supply power to a sensor unit (not shown) and a control unit (not shown).

The battery can be charged by an external power source, and for this purpose, a charging terminal 280 for charging may be provided at one side of the body 210. For example, the charging terminal 280 may be disposed at the rear side of the outer surface of the body 210. When the robot cleaner 200 is coupled to the robot cleaner station 100, the charging terminal 280 comes into contact with the power supply terminal 123b of the robot cleaner station 100 to receive power.

### Robot Cleaner Station

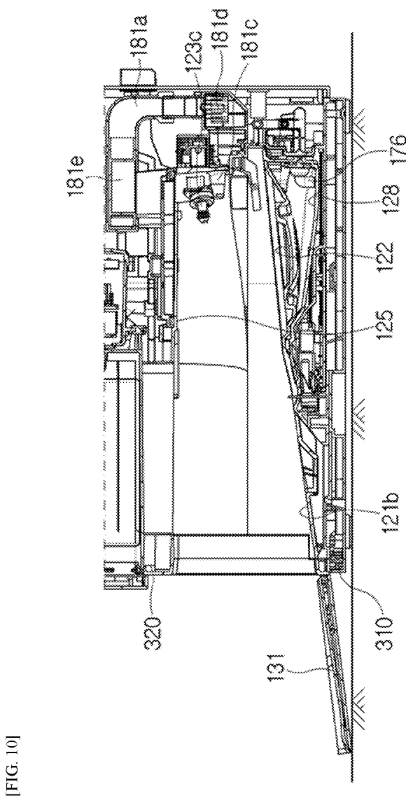

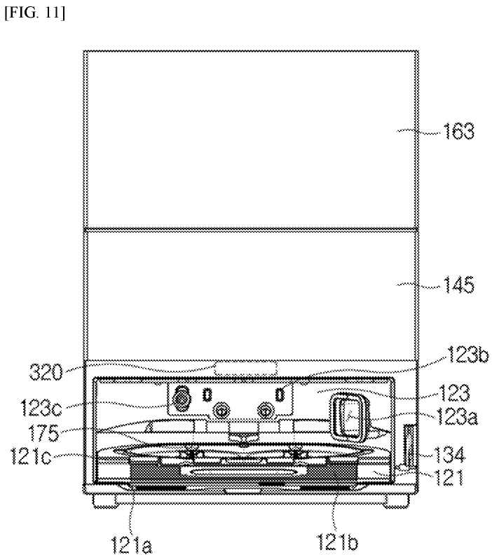

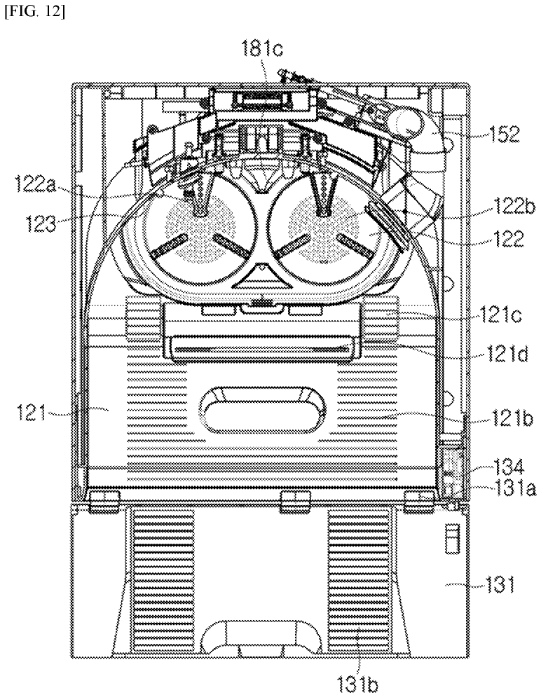

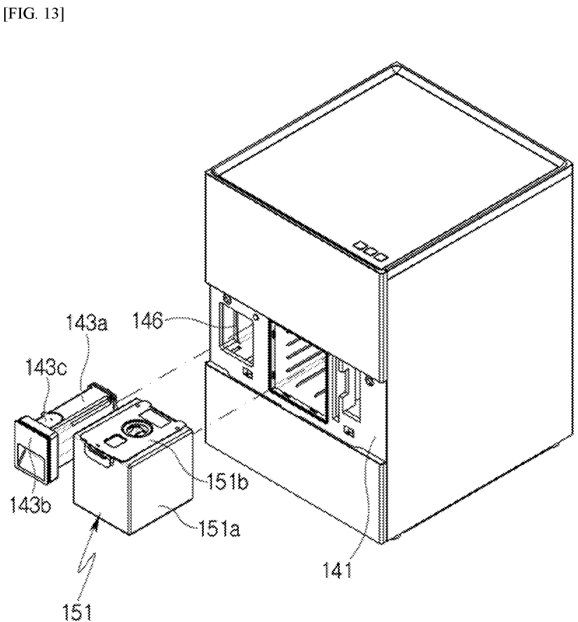

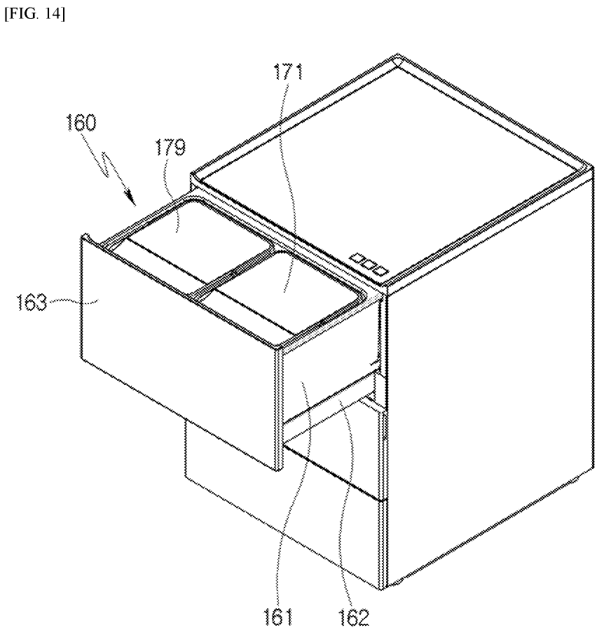

FIG. 9 is a perspective view for explaining a state in which a door is opened in a robot cleaner station according to an embodiment of the present disclosure, FIG. 10 is an enlarged cross-sectional view of FIGS. 4 and 11 is a front view of FIGS. 9 and 12 is a view for explaining a seating part in the robot cleaner station according to the embodiment of the present disclosure, FIG. 13 is a perspective view for explaining a direction in which a dust bag and a detergent tank are extracted in the robot cleaner station according to the embodiment of the present disclosure, and FIG. 14 is a perspective view for explaining that a drawer is extracted in the robot cleaner station according to the embodiment of the present disclosure.

The robot cleaner station 100 of the present disclosure will be described with reference to FIGS. 9 to 14 as follows.

A robot cleaner 200 may be accommodated in the robot cleaner station 100. The robot cleaner 200 may be seated on a seating part 120 of the robot cleaner station 100.

The robot cleaner station 100 may include a housing 110.

The housing 110 may form the appearance of the robot cleaner station 100. For example, the housing 110 may be formed in a shape similar to a hexahedron.

The housing 110 may include a space formed therein capable of accommodating the seating part 120, a storage unit 140, a dust collection unit 150, a drawer 160, a mop washing unit 170, and a mop drying unit 180.

The housing 110 may include a front surface 111. The front surface 111 may be disposed at the front of the robot cleaner station 100.

Here, the front may refer to a direction in which a door 131 is provided based on the inside of the robot cleaner station 100.

Further, the rear may refer to a direction opposite to the front based on the inside of the robot cleaner station 100.

Further, based on viewed toward the front from the inside of the robot cleaner station 100, the left side may be referred to as a leftward direction and the right side may be referred to as a rightward direction.

The front surface 111 may be formed in a shape of a rectangular surface as a whole.

An entrance 111a through which the robot cleaner 200 enters and exits may be formed on the front surface 111. The drawer 160 may be extracted from the front surface 111. A storage unit cover 145 and a drawer cover 163 may be provided on the front surface 111. A space capable of storing items may be formed on the front surface 111.

Accordingly, the front surface 111 may have an appearance in a shape similar to a chest of drawers.

Further, the robot cleaner 200 may enter into the seating part 120 through the front surface 111. Accordingly, according to the present disclosure, there is an effect of providing an aesthetic appearance like indoor furniture without exposing the robot cleaner 200 to the outside.

The housing 110 may include a rear surface 112. The rear surface 112 may be disposed at the rear of the robot cleaner station 100. The rear surface 112 may be disposed on the opposite side of the front surface 111 based on a dust collection motor 153. The rear surface 112 may be formed in a shape corresponding to the shape of the front surface 111. For example, the rear surface 112 may be formed in a shape of a rectangular surface. An exhaust port 112a may be formed on the rear surface 112.

The housing 110 may include an upper surface 113. The upper surface 113 may cover the upper side of the drawer 160. For example, the upper surface 113 may be formed in a shape of a rectangular surface. At this time, the upper surface 113 may be formed in a shape in which a rim portion protrudes by a predetermined height. That is, the upper surface 113 may be formed in a shape having a concave interior. Items may be placed on the upper side of the upper surface 113. Specifically, a charging part 113a for charging an electronic device may be provided on the upper surface 113. Accordingly, when the electronic device is placed on the upper surface 113, the electronic device may be charged.

The housing 110 may include a lower surface 114. The lower surface 114 may be disposed to face the ground. The lower surface 114 is disposed at the lower side of a base 121 to support the base 121. A plurality of legs 115 may be provided at the lower side of the lower surface 114.

The legs 115 may support the lower side of the housing 110. The legs 115 may contact the ground to support the housing 110. Accordingly, the lower surface 114 may be spaced apart from the ground (floor of a kitchen) by a predetermined height.

The robot cleaner 200 and the robot cleaner station 100 may be physically, electrically, and/or fluidly connected through the seating part 120.

The seating part 120 may be disposed inside the housing 110.

An entrance 127 into which the robot cleaner 200 is inserted may be formed at the front of the seating part 120. The entrance 127 may refer to a space formed on the front surface of the robot cleaner station 100.

The entrance 127 may be formed in a size through which the robot cleaner 200 can pass. That is, a height of the entrance 127 is formed to be larger than a height of the robot cleaner 200. At this time, the entrance 127 may refer to a space formed upward along a vertical direction from a front end portion of the base 121, which will be described later. Alternatively, the entrance 127 may refer to a space formed in a door frame 132, which will be described later, through which the robot cleaner 200 passes.

At this time, the entrance 127 may be opened and closed by the door 131.

The seating part 120 may include an accommodation space S, the base 121, a docking wall 123, and an inner wall 124.

The robot cleaner 200 may be accommodated in the accommodation space S of the seating part 120. For example, the accommodation space S may refer to a space surrounded by the base 121, the docking wall 123, and the inner wall 124. As another example, the accommodation space S may refer to a space surrounded by the base 121, a washing plate 122, the docking wall 123, and the inner wall 124. As still another example, the accommodation space S may refer to a space where the robot cleaner 200 is positioned in a state where the robot cleaner 200 is coupled to a power supply terminal 123b, or a space where the robot cleaner 200 is positioned in a state where the dust bin 220 of the robot cleaner 200 communicates with a dust passage hole 123a.

The base 121 is a configuration capable of supporting the robot cleaner 200 when the robot cleaner 200 enters the robot cleaner station 100. The wheels 260 of the robot cleaner 200 may contact the upper surface of the base 121. Further, the auxiliary wheel 270 of the robot cleaner 200 may contact the upper surface of the base 121.

The base 121 may include a base body 121a, an inclined part 121b, a wheel coupling part 121c, an agitator accommodation part 121d, and a washing tub 128.

The base body 121a may form the overall appearance of the base 121. The inclined part 121b, the wheel coupling part 121c, the agitator accommodation part 121d, and the washing tub 128 may be disposed on the base body 121a.

The inclined part 121b may be disposed at an inlet where the robot cleaner 200 climbs from the base body 121a.

The inclined part 121b may have an upward inclination toward the front in a direction in which the robot cleaner 200 enters. More specifically, a front end portion of the inclined part 121b is connected so as not to have a height difference from the lower surface 114, but may have an inclination that rises toward the rear. That is, the inclined part 121b may be formed to gradually rise when the robot cleaner 200 enters.

The wheels 260 of the robot cleaner 200 that have moved upward along the inclined part 121b may be seated on the wheel coupling part 121c. When the wheels 260 of the robot cleaner 200 are seated on the wheel coupling part 121c, a physical coupling between the robot cleaner 200 and the robot cleaner station 100 may be achieved. A surface of the wheel coupling part 121c may be formed to correspond to a surface of the wheel 260 so that the robot cleaner 200 can stably stop.

The wheel coupling part 121c may be disposed at a stop position of the left and right wheels 260 of the robot cleaner 200 so that the robot cleaner 200 stops at a correct position. Here, the stop position of the wheel 260 refers to a position determined to stop for the robot cleaner 200 to be coupled to the power supply terminal 123b and/or a position determined to stop for the dust bin 220 of the robot cleaner 200 to communicate with the dust passage hole 123a.

The docking wall 123 is a configuration in which the dust passage hole 123a, the power supply terminal 123b, and a water supply nozzle 123c of the robot cleaner station 100 are disposed. The docking wall 123 can spatially separate the accommodation space S from components of the robot cleaner station 100. The docking wall 123 may extend along the vertical direction from the rear side of the base 121. The docking wall 123 may be formed to correspond to the shape of the robot cleaner 200. For example, when the body 210 of the robot cleaner 200 is in a cylindrical shape, the docking wall 123 may be formed in an arc shape having a predetermined radius. With such a configuration, it can surround the periphery of the robot cleaner 200 and increase an area capable of facing the outer surface of the robot cleaner 200. Further, it can stably support the robot cleaner 200.

The dust passage hole 123a may be formed in the seating part 120 so that air outside the housing 110 can be introduced into the inside. Specifically, the dust passage hole 123a may be formed in the docking wall 123 so that air outside the housing 110 can be introduced into the inside.

The dust passage hole 123a may communicate with the dust bin 220 of the robot cleaner 200. The dust passage hole 123a may communicate with the dust discharge port 221 of the dust bin 220 of the robot cleaner 200. The dust passage hole 123a may be formed in a shape of a hole corresponding to the shape of the dust bin 220 so that dust in the dust bin 220 is introduced into the dust collection unit 150.

The dust passage hole 123a may be formed to communicate with a dust collection flow path part 152.

The robot cleaner station 100 may include a power supply module supplying power to the robot cleaner 200. The power supply module includes a power supply module housing and the power supply terminal 123b, and a circuit board and a device for supplying power may be mounted in the power supply module housing. Further, the power supply terminal 123b is disposed at the front of the power supply module housing and may be disposed to be exposed on the docking wall 123.

The power supply terminal 123b can supply power to the robot cleaner 200 coupled to the seating part 120. The power supply terminal 123b may contact a charging terminal of the robot cleaner 200 to be electrically connected. The power supply terminal 123b may be disposed at the seating part 120. Specifically, the power supply terminal 123b may be disposed on the docking wall 123. The power supply terminal 123b may be electrically connected to the robot cleaner 200 coupled to the docking wall 123. The power supply terminal 123b can supply power to a battery of the robot cleaner 200 coupled to the docking wall 123.

The robot cleaner station 100 may further include the water supply nozzle 123c.

The water supply nozzle 123c may be connected to the supply part 231 of the water tank 230 of the robot cleaner 200. Specifically, the water supply nozzle 123c may be connected to the injection port of the water tank 230. The water supply nozzle 123c can supply water supplied from a washing water tank 171 to the storage space inside the water tank 230 of the robot cleaner 200.

The inner wall 124 may be formed on lateral inner surfaces of the housing 110. A pair of inner walls 124 may be disposed at left and right sides of the base 121. The inner walls 124 may be connected to both ends of the docking wall 123.

The washing plate 122 is a configuration for washing the mop of the robot cleaner 200, and the washing plate 122 may be seated in the washing tub 128 of the base 121. Further, the washing plate 122 may contact the mop 242 in a state where the robot cleaner 200 is seated.

The washing plate 122 may be a plate formed to be inclined downward toward the center portion as a whole.

Specifically, the washing plate 122 includes a flow guide surface formed in a curved shape. Further, at least one passage hole 122b through which a fluid can pass may be formed on the flow guide surface. Further, washing protrusions 122a may be formed to protrude on the flow guide surface.

At this time, a pair of washing protrusions 122a may be symmetrically formed on the flow guide surface. Specifically, the pair of washing protrusions 122a are disposed at the vertically lower side of the pair of mops 242 of the robot cleaner 200, are disposed to face the pair of mops 242, and may be disposed to be contactable with at least a portion of the pair of mops 242.

Further, a plurality of passage holes 122b are formed on the flow guide surface, and may be formed between the pair of washing protrusions 122a. For example, the plurality of passage holes 122b are formed including a position where the height from the ground (floor of a kitchen) is lowest among the flow guide surface, and may be formed between the pair of washing protrusions 122a. Through this, the fluid discharged between the pair of washing protrusions 122a can flow while being guided to the passage hole 122b.

Meanwhile, the flow guide surface may have a height from the floor of the kitchen that increases toward the rear from the position where the passage hole 122b is formed. That is, the flow guide surface may have a height from the floor of the kitchen that increases as it gets closer to an external air discharge part 181c, which will be described later.

With this configuration, washing water and/or air flows along the flow guide surface and may escape into a space formed between the washing plate 122 and the washing tub 128 through the passage hole 122b.

When washing water is supplied to the washing plate 122 and the mop 242 rotates, the mop 242 may be washed while being frictioned with the washing protrusion 122a in a stationary state.

The washing tub 128 is a configuration in which the washing plate 122 is seated. The washing tub 128 may be disposed at the rear side of the base body 121a. The washing tub 128 is disposed at the lower side of the washing plate 122 and is detachably coupled to the washing plate 122. The washing tub 128 may be formed to correspond to the washing plate 122 so that the washing plate 122 can be inserted therein. The liquid that has passed through the washing plate 122 may be introduced into the washing tub 128.

The washing tub 128 may include a washing tub base surface through which the fluid that has passed through the washing plate 122 flows and a washing tub wall formed to protrude and extend along a vertical direction from the periphery of the washing tub base surface. At this time, the washing tub base surface may have a height from the ground (floor of a kitchen) that decreases toward the rear of the robot cleaner station 100. Through this, the fluid that has passed through the washing plate 122 can be collected toward the rear of the washing tub 128 and discharged to the outside through a wastewater suction part 175, which will be described later.

A door unit 130 may be provided so as to cover a portion of a lower side of a front end of the housing 110.

The door unit 130 includes the door 131. The door 131 may form the front appearance of the robot cleaner station 100 in a state where the entrance 127 is closed. For example, the door 131 may be formed close to a rectangular flat plate shape. A length of the door 131 in a lateral direction may be provided to be greater than or equal to a length of the housing 110 in the lateral direction. With such a configuration, there is an effect that the appearance of the robot cleaner station 100 becomes clean.

The door frame 132 may be disposed at the front lower side of the housing 110. The door 131 is coupled to the door frame 132 so as to be openable and closable. Further, the entrance 127 through which the robot cleaner 200 can enter and exit may be formed in the door frame 132.

The door frame 132 may form the front appearance of the robot cleaner station 100 in a state where the door 131 is opened.

In the door 131, a rotation shaft 131a is disposed at a lower end of the door frame 132, and when opening the entrance 127, it may be disposed parallel to the floor surface or formed with a downward inclination toward the front so that an end portion thereof contacts the ground.

The door 131 includes a hinge part and may be rotatably connected to the door frame 132. A plurality of hinge parts may be disposed apart along the rotation shaft 131a, and may be disposed apart from each other at different intervals.

Further, the door 131 may include an auxiliary approach path 131b on a surface facing the housing 110 when closing the entrance 127. The auxiliary approach path 131b is provided so that the robot cleaner 200 can stably travel to the seating part 120 or the entrance 127, and may be provided with an upward inclination toward the rear.

Specifically, the auxiliary approach path 131b may be formed in a shape of a groove for stable inclined traveling of the robot cleaner 200. In the auxiliary approach path 131b, grooves formed along the lateral direction may be disposed apart at equal intervals in the front-rear direction. Such an auxiliary approach path 131b may be formed so that a width in the lateral direction becomes narrower toward the rear. Accordingly, as the wheels 260 of the robot cleaner 200 head toward the seating part 120 or the entrance 127, the lateral movement is restricted and it can be guided to a correct position.

The auxiliary approach path 131b guides the wheels 260 to a wheel guide part 121ba disposed at the seating part 120. The auxiliary approach path 131b may be provided as a pair and disposed at respective positions continuous with a pair of wheel guide parts 121ba.

The door 131 can be rotated by a door driving part 134. For example, the door driving part 134 may include a door driving motor and a driving link part.

The door driving motor may be disposed inside the housing 110 and disposed in an upper space of the door frame 132. Specifically, the door driving motor may be disposed in a storage unit body 141. For example, the door driving motor may be disposed at an upper side of the driving link part.

Through this, space utilization is improved and accessibility is improved, thereby providing convenience to the user.

The driving link part is provided to connect between the door driving motor and the door 131 to transfer power. The driving link part may include at least one link to transfer the driving force of the door driving motor to the door 131 to rotate the door 131.

The robot cleaner station 100 of the present disclosure includes a storage unit 140. The storage unit 140 may provide at least one storage space.

Based on a vertical direction of the robot cleaner station 100, the storage unit 140 may be disposed between the seating part 120 and the drawer 160. Specifically, the storage unit 140 may be disposed at an upper side of the seating part 120. Further, the storage unit 140 may be disposed at a lower side of the drawer 160.

The storage unit 140 includes a storage unit body 141. The storage unit body 141 may provide a space in which items can be stored. Specifically, the storage unit body 141 may be disposed at the front of the housing 110. At this time, the storage unit body 141 may be disposed at the upper side of the entrance 127. The storage unit body 141 and the seating part 120 may be partitioned with a seating part cover 125 as a boundary.

Specifically, a space capable of accommodating a dust bag 151 may be formed in the storage unit body 141. A space capable of accommodating a storage unit drawer 143 may be formed in the storage unit body 141, and a space capable of storing items such as consumables of the robot cleaner station 100 or the robot cleaner 200 may be formed in the storage unit body 141.

The storage unit body 141 may be covered by a storage unit cover 145. Specifically, the storage space formed in the storage unit body 141 may be exposed to the outside when the storage unit cover 145 is separated. Accordingly, in a state where the storage unit cover 145 is separated or opened, the storage unit body 141 is disposed at the front of the robot cleaner station 100, is formed in a plate shape along the vertical direction, and may be exposed in a state where a plurality of holes are formed.

On the other hand, the storage space is closed when the storage unit cover 145 is closed, so that it may not be visible from the outside. Accordingly, according to the present disclosure, there is an effect of providing an aesthetic appearance like indoor furniture without exposing items stored in the robot cleaner station 100 to the outside.

A dust bag housing 142 may form a space therein capable of accommodating a filter (not shown) and the dust bag 151.

The dust bag 151 may be extractably coupled inside the dust bag housing 142. For example, the dust bag housing 142 is formed in a shape of a rectangular tube with an open front, and a rear internal space may communicate with a dust collection flow path part 152 and a dust collection motor housing 154.

Dust inside the dust bin 220 may be introduced into the dust bag housing 142.

An upper side of the dust bag housing 142 may be connected to the dust collection flow path part 152, and a rear side thereof may be connected to the dust collection motor housing 154. Specifically, an inlet may be formed on an upper surface of the dust bag housing 142, and an outlet may be formed on a rear surface thereof.

Accordingly, the internal space of the dust bag housing 142 may communicate with a dust collection flow path formed in the dust collection flow path part 152, and may communicate with an internal space of the dust collection motor housing 154. Further, when the dust bag 151 is coupled to the dust bag housing 142, the dust bag 151 may communicate with the dust collection flow path part 152 inside the dust bag housing 142.

Therefore, when the dust collection motor 153 is operated, dust inside the dust bin 220 flows along the dust collection flow path to be introduced into the dust bag housing 142, and may be discharged to the dust collection motor housing 154 through the dust bag 151.

The storage unit drawer 143 may be provided so as to be extractable from the storage unit body 141. The storage unit drawer 143 may be extracted forward from the storage unit body 141. At this time, an extraction direction of the storage unit drawer 143 may be the same as an extraction direction of the drawer 160. Further, the storage unit drawer 143 may be extracted in a direction intersecting a direction in which a washing water tank 171 and a wastewater tank 179 are separated from the drawer 160.

The storage unit drawer 143 may be disposed at one side of the dust bag housing 142 in a lateral direction.

The storage unit drawer 143 includes a drawer body 143a, a handle 143b, and a cap 143c.

The storage unit drawer 143 may form a storage space therein. Specifically, the storage unit drawer body 143a may be formed in a box shape with an open upper side. For example, the storage unit drawer 143 may be a detergent tank. The storage unit drawer body 143a may provide a space capable of storing a liquid including a detergent.

The handle 143b may be provided at the front of the storage unit drawer body 143a. The handle 143b may be provided so as to be grippable by a user. For example, the handle 143b may be formed to be recessed toward the rear from a front surface of the storage unit drawer body 143a.

With such a configuration, when the user pulls the handle 143b forward, the storage unit drawer body 143a is pulled forward together and can be extracted. Accordingly, according to the present disclosure, the user can easily pull the storage unit drawer 143 forward and then supply the detergent.

Meanwhile, the storage unit drawer 143 may be provided with an injection port through which a liquid can be injected and the cap 143c capable of blocking the injection port. The injection port may be formed on an upper surface of the storage unit drawer 143. Meanwhile, the cap 143c may be formed in a shape corresponding to the shape of the injection port so as to seal the injection port. For example, if the injection port is a circular hole, the cap 143c may include a coupling part that is formed to have the same diameter as a diameter of the injection port and is inserted into the injection port to block the injection port.

A storage box 144 may be formed so that items can be stored. The storage box 144 may be formed to be recessed toward the rear in the storage unit body 141. For example, the storage box 144 may be formed to be recessed in a shape of a rectangular groove.

The storage box 144 may be disposed at the other side of the dust bag housing 142 in the lateral direction. The storage box 144 may be disposed on the opposite side of the storage unit drawer 143 based on the dust bag housing 142.

At least one storage box 144 may be formed. For example, the storage box 144 may include a first storage box 144a and a second storage box 144b. At this time, the first storage box 144a and the second storage box 144b may be formed to have different heights and widths. Accordingly, different items may be stored in the first storage box 144a and the second storage box 144b. For example, an unused dust bag 151 may be stored in the first storage box 144a, and an unused or dried mop 242 may be stored in the second storage unit 144b.

The storage unit cover 145 may cover the storage unit body 141. The storage unit cover 145 may cover the front of the storage unit body 141. For example, the storage unit cover 145 may be formed in a shape of a rectangular plate.

As an example, the storage unit cover 145 may be detachably coupled to the storage unit body 141. A magnet is provided on the storage unit cover 145 so as to be detachably coupled to the storage unit body 141. Accordingly, the user may separate the storage unit cover 145 from the storage unit body 141 to expose the storage unit body 141 to the outside.

As another example, the storage unit cover 145 may be hingedly coupled to the storage unit body 141. Specifically, the storage unit cover 145 includes a hinge part 145a, and the hinge part 145a may be provided at a lateral end portion of the storage unit body 141. At this time, a rotation shaft of the hinge part 145a may be disposed along the vertical direction. With such a configuration, even if the storage unit cover 145 is opened, it is possible to prevent the storage unit cover 145 from sagging downward to block the entrance 127 or interfering with the opening of the door 131.

A drawer housing 146 may be provided in the storage unit 140. The drawer housing 146 may accommodate the storage unit drawer body 143a.

The drawer housing 146 may guide the movement of the storage unit drawer body 143a. For example, the drawer housing 146 may be formed in a box shape with an open front. At this time, a width of the drawer housing 146 may be formed to be larger than a diameter of the storage unit drawer body 143a.

With such a configuration, when the user couples the storage unit drawer 143 to the housing 110, it can be coupled at a correct position, and the leakage of washing water can be prevented.

The dust collection unit 150 can collect dust from the dust bin 220 of the robot cleaner 200. The dust collection unit 150 may be disposed inside the housing 110. The dust collection unit 150 may be disposed at the upper side of the base 121.

The dust collection unit 150 may include a filter (not shown), the dust bag 151, the dust collection flow path part 152, the dust collection motor 153, the motor housing 154, and an exhaust flow path part 155.

The filter (not shown) may be provided in the dust bag housing 142.

Meanwhile, the filter (not shown) may be disposed lower than the inlet of the dust bag housing 142. The filter (not shown) may be disposed at the front of the outlet of the dust bag housing 142.

The dust bag 151 may refer to a dust pouch for collecting dust suctioned from the inside of the dust bin 220 of the robot cleaner 200 by the dust collection motor 153.

The dust bag 151 may be detachably coupled to the dust bag housing 142. The dust bag 151 may be provided so as to be extractable from the dust bag housing 142. Accordingly, the dust bag 151 can be separated from the dust bag housing 142 and discarded, and a new dust bag 151 can be coupled to the dust bag housing 142. That is, the dust bag 151 may be defined as a consumable part.

An inlet of the dust bag 151 may be disposed to communicate with the inlet of the dust bag housing 142. Accordingly, when the dust collection motor 153 is operated, air and dust in the dust bin 220 may be introduced into the inside of the dust bag 151 and collected.

Specifically, the dust bag 151 includes a bag 151a and a dust bag plate 151b. At this time, the bag 151a may be provided so that dust is accommodated therein while a volume increases when a suction force is generated by the dust collection motor 153. For this purpose, the bag 151a may be provided of a material that is air-permeable but not permeable to foreign substances such as dust. For example, the bag 151a may be made of a non-woven fabric material, and may have a hexahedron shape corresponding to the shape of the dust bag housing 142 based on when the volume increases.

The dust bag plate 151b may be disposed at one side of the bag 151a. An inlet through which air can be introduced may be formed in the dust bag plate 151b. Accordingly, when the dust collection motor 153 is operated in a state where the dust bag 151 is coupled to the dust bag housing 142, air and dust that have passed through the dust collection flow path part 152 may pass through the dust bag plate 151b and be introduced into the inside of the bag 151a. Further, according to the embodiment, the dust bag plate 151b may be provided with a window through which light including ultraviolet rays can be transmitted. Accordingly, when a sterilization module (not shown) disposed in the dust bag housing 142 irradiates light in the state where the dust bag 151 is coupled to the dust bag housing 142, it can transmit through the window and sterilize the inside of the bag 151a.

The dust bag plate 151b may be detachably coupled to the dust bag housing 142. The dust bag plate 151b may be provided so as to be extractable and insertable along a guide part provided in the dust bag housing 142. Through this, the dust bag 151 can be coupled at a correct position of the dust bag housing 142.

The dust collection unit 150 may further include a dust collection module. The dust collection module can provide a suction airflow to the dust collection flow path part 152.

Specifically, the dust collection unit 150 may further include the dust collection motor 153 and the dust collection motor housing 154.

The dust collection motor 153 can generate a suction force in the dust collection flow path part 152. That is, the dust collection motor 153 can provide a suction force for suctioning dust in the dust bin 220 into the dust bag 151 disposed in the dust bag housing 142.

The dust collection motor 153 may be disposed at the rear of the dust bag housing 142. Through this, the dust collection motor 153 can provide a suction force capable of suctioning dust in the dust bin 220 of the robot cleaner 200.

The dust collection motor 153 can generate a suction force by rotation. As an example, although not shown, the dust collection motor 153 includes a rotor and a stator that relatively rotate by receiving power, and may include an impeller that rotates around a rotation shaft according to the rotation of the rotor. Accordingly, a suction force may be generated by the rotation of the impeller.

One side of the dust collection motor 153 may be connected to the dust bag housing 142, and the other side may be connected to the exhaust flow path part 155. When the dust collection motor 153 is driven, air flowing through the dust collection flow path part 152 may be introduced into the inside of the dust collection motor housing 154. Further, air introduced into the inside of the dust collection motor housing 154 may be discharged to the outside of the dust collection motor housing 154 after passing through the dust collection motor 153.

Meanwhile, in the present embodiment, a motor shaft 153a of the dust collection motor 153 may be disposed along a horizontal direction.

The dust collection motor housing 154 can accommodate the dust collection motor 153 therein. The dust collection motor housing 154 may be disposed at the rear of the dust bag housing 142. The dust collection motor housing 154 may be disposed more rearward than an upper end of the dust collection flow path part 152. The dust collection motor housing 154 may be disposed lower than the upper end of the dust collection flow path part 152. On the other hand, the dust collection motor housing 154 may be disposed more forward than a lower end of the dust collection flow path part 152. The dust collection motor housing 154 may be disposed higher than the lower end of the dust collection flow path part 152.

Meanwhile, the dust collection unit 150 may further include the dust collection flow path part 152. One longitudinal end portion of the dust collection flow path part 152 is connected to the dust bag housing 142, and the other longitudinal end portion is connected to the docking wall 123. The dust collection flow path part 152 may refer to a flow path through which air suctioned through the dust passage hole 123a flows via the dust bag 151 to reach the dust collection motor 153.

Specifically, when the robot cleaner 200 is docked with the robot cleaner station 100 and the dust passage hole 123a communicates with the dust bin 220 of the robot cleaner 200, the dust collection flow path part 152 can communicate the dust bin 220 with the internal space of the dust bag housing 142.

The dust collection flow path part 152 can connect the dust bin 220 of the robot cleaner 200 with the internal space of the dust bag housing 142. The dust collection flow path part 152 can connect the dust passage hole 123a with the internal space of the dust bag housing 142.

The dust collection flow path part 152 may be connected to a rear surface of the docking wall 123. At this time, the dust passage hole 123a is formed in the docking wall 123, and a dust collection flow path is formed in the dust collection flow path part 152 so as to communicate with each other. Accordingly, when the dust collection motor 153 is operated, air and dust inside the dust bin 220 can flow through the dust collection flow path via the dust passage hole 123a.

Meanwhile, the dust collection flow path part 152 may be disposed to be inclined. Specifically, at least a portion of the dust collection flow path part 152 may be disposed to be inclined along the lateral direction. Further, at least a portion of the dust collection flow path part 152 may be disposed to be inclined along the front-rear direction.

The dust collection flow path part 152 may be arranged in a shape of extending rearward from the dust passage hole 123a and then being bent toward the upper front side. At this time, the dust collection flow path part 152 may be disposed to be inclined from one side in the lateral direction where the dust passage hole 123a is formed toward a lateral center portion of the housing 110.

Meanwhile, the dust collection flow path part 152 is connected to an upper surface of the dust bag housing 142. That is, one longitudinal end portion of the dust collection flow path part 152 is connected to the upper surface of the dust bag housing 142. At this time, an upper portion of the dust collection flow path part 152 may be disposed to be inclined upward and then bent downward to be connected to the dust bag housing 142. Accordingly, an upper end of the dust collection flow path part 152 may be disposed higher from the ground (floor) than the upper surface of the dust bag housing 142.

Further, the upper portion of the dust collection flow path part 152 may be disposed at the lateral center portion of the robot cleaner station 100. At this time, at least a portion of the dust collection flow path part 152 may be disposed between the washing water tank 171 and the wastewater tank 179. Specifically, the upper end of the dust collection flow path part 152 may be disposed between the washing water tank 171 and the wastewater tank 179.

Accordingly, the washing water tank 171 and the wastewater tank 179 are disposed on left and right sides at the upper side of the dust collection flow path part 152, and the dust collection flow path part 152 may be disposed between the washing water tank 171 and the wastewater tank 179.

With such a configuration, a volume occupied by the dust collection flow path part 152 along the lateral direction within the robot cleaner station 100 can be minimized. Further, a volume in which the dust bag 151 can expand within a limited space can be maximized.

The lateral width can be made narrow, and at the same time, the volume of the dust bag 151 can be maximized.

The dust collection motor housing 154 can provide a space in which the dust collection motor 153 is accommodated. For example, the dust collection motor housing 154 may be formed in a cylindrical or rectangular tube shape.

The dust collection motor housing 154 may be disposed more rearward than the dust bag housing 142. An internal space of the dust collection motor housing 154 may communicate with the internal space of the dust bag housing 142. Specifically, an air inlet may be formed in the dust collection motor housing 154. The air inlet of the dust collection motor housing 154 may communicate with an air outlet of the dust bag housing 142.

Further, an air outlet may be formed in the dust collection motor housing 154. The air outlet of the dust collection motor housing 154 may communicate with a flow path formed in the exhaust flow path part 155.

The exhaust flow path part 155 can discharge air discharged from the dust collection motor 153. An inlet of the exhaust flow path part 155 may communicate with the internal space of the dust collection motor housing 154. Further, a discharge port of the exhaust flow path part 155 may be formed on the rear surface 112 of the housing 110. Accordingly, the exhaust flow path part 155 can discharge air that has passed through the dust collection motor 153 to the outside of the robot cleaner station 100.

Meanwhile, FIG. 14 illustrates a drawer 160 of a robot cleaner station 100 according to an embodiment of the present disclosure.

The drawer 160 according to the embodiment of the present disclosure will be described with reference to FIG. 14 as follows.

The robot cleaner station 100 according to the embodiment of the present disclosure includes the drawer 160. The drawer 160 is disposed in the housing 110 and may be provided so as to be extractable from the housing 110.

The drawer 160 can be extracted from the housing 110. The drawer 160 can be extracted from the housing 110 along a first direction. Specifically, the drawer 160 can be extracted forward from the housing 110. The drawer 160 can be extracted in a direction in which the door 131 is disposed.

Meanwhile, at least one liquid tank 171, 179 may be accommodated in the drawer 160. Specifically, the washing water tank 171 and the wastewater tank 179 may be accommodated in the drawer 160. The washing water tank 171 and the wastewater tank 179 may be accommodated so as to be separable from the drawer 160. At this time, the washing water tank 171 and the wastewater tank 179 may be separated from the drawer 160 along a second direction. The second direction may be a direction intersecting the first direction. For example, the second direction may be a vertical direction.

Through this, even in a state where the washing water tank 171 and/or the wastewater tank 179 is full of liquid, the drawer 160 can support the washing water tank 171 and/or the wastewater tank 179, and a user can separate or couple the washing water tank 171 and/or the wastewater tank 179 from or to the drawer 160 by a simple operation of lifting or putting down the washing water tank 171 and/or the wastewater tank 179.

Meanwhile, with reference to FIG. 14, a position where the user can couple or separate the washing water tank 171 and/or the wastewater tank 179 to or from the drawer 160 without bending his or her waist will be described as follows.

In order for the user to separate or couple the liquid tanks 171, 179 to or from the drawer 160 without bending the waist, the user must horizontally move the liquid tanks 171, 179, or couple or separate the liquid tanks 171, 179 to or from the drawer 160 by only adding a simple operation of moving a wrist or a forearm thereto.

Accordingly, the minimum height at which the user can detachably attach the liquid tanks 171, 179 to or from the drawer 160 without bending the waist may refer to a height from the ground to the bottom of a palm based on when the user drops an arm in a standing state. This is a height at which the user can pull a handle of the drawer 160 without bending the waist, and may be a height at which the user can grip a handle of the liquid tanks 171, 179 without bending the waist.

As an example, the height of an upper end of the drawer may be 50 cm or more from the ground.

Specifically, when calculating the height of a fingertip from the ground, it may be a value obtained by subtracting an upper arm length, a forearm length, and a hand length from an outer shoulder height.

At this time, in order to calculate the minimum height at which the user can catch the handle of the liquid tanks 171, 179 without bending the waist, using the human body dimensions of a woman aged 60 or older who has the smallest average height among adults, it is about 50 cm (based on the Korean Agency for Technology and Standards).

Therefore, the shortest distance from the ground of the upper end of the drawer 160 may be 50 cm or more.

Meanwhile, if the user can couple the liquid tanks 171, 179 to the drawer 160 using only the forearm or the wrist without rotating the upper arm, the user can provide convenience without exerting relatively large force.

Accordingly, the maximum height at which the user can conveniently couple the liquid tanks 171, 179 to the drawer 160 may refer to a height from the ground to an elbow (bottom of the upper arm) based on when the user drops the arm in the standing state. At this time, if the height of the elbow is less than or equal to a height obtained by adding the height of the liquid tanks 171, 179 to the height of the upper end of the drawer 160, the user can separate and couple the liquid tanks 171, 179 from and to the drawer 160 by lifting only the forearm.

As an example, the sum of the heights of the liquid tanks 171, 179 and the upper end of the drawer 160 may be 108 cm or less from the ground.

Specifically, when calculating the height from the ground to the elbow, it may be a value (A-B) obtained by subtracting the upper arm length (B) from the outer shoulder height (A).

At this time, using the human body dimensions of a man in his 30s who has the largest height from the ground to the elbow among adults, it is about 107.6 cm. Considering a diameter of the handle of the liquid tanks 171, 179, etc., it is preferable that the sum of the heights of the liquid tanks 171, 179 and the upper end of the drawer 160 is at most 108 cm or less.

With such a configuration, the user can comfortably detachably attach the liquid tanks 171, 179 to or from the drawer 160 without bending the waist.

Meanwhile, the drawer 160 may be disposed at an upper portion within the housing 110. The drawer 160 may be disposed at the lower side of the upper surface 113 of the housing 110. Accordingly, the drawer 160 may be disposed at the lower side of the charging part 113a.

When the height of the drawer 160 and the liquid tanks 171, 179 is secured as described above, a space capable of storing items can be secured between the base 121 on which the robot cleaner 200 is seated and the drawer 160. Accordingly, the storage unit 140 may be disposed at the lower side of the drawer 160. Specifically, the drawer 160 may be disposed at the upper side of the dust bag 151. Further, the drawer 160 may be disposed at the upper side of the storage unit drawer 143. Further, the drawer 160 may be disposed at the upper side of the storage box 144.

The drawer 160 may include a drawer body 161, rails 162, and a drawer cover 163.

The drawer body 161 can accommodate the liquid tanks 171, 179 therein. Specifically, a liquid tank accommodation part may be provided in the drawer body 161. The liquid tank accommodation part can provide a space capable of accommodating the washing water tank 171 and the wastewater tank 179. The liquid tank accommodation part may be in a shape in which the inside of the drawer body 161 is recessed. At this time, the liquid tank accommodation part may be formed such that a width in the lateral direction is larger than a width in the front-rear direction. Accordingly, the washing water tank 171 and the wastewater tank 179 may be disposed along the lateral direction within the liquid tank accommodation part. With such a configuration, a distance that the drawer 160 must be extracted forward in order to separate the washing water tank 171 and the wastewater tank 179 can be minimized.

Meanwhile, a plurality of ports communicating with the inside of the liquid tanks 171, 179 may be formed in the liquid tank accommodation part. Through the ports, fresh water in the washing water tank 171 can be discharged to a washing water flow path part 173, or wastewater discharged from a wastewater suction part 176 can be introduced into the wastewater tank 179.

Specifically, a washing water supply port 161a may be formed in the drawer body 161. One side of the washing water supply port 161a is connected to the washing water flow path part 173, and the other side may be connected to a washing water supply port 171d of the washing water tank 171. Accordingly, when a washing water pump 173b is operated, washing water can pass through the washing water supply port 161a.

Further, a negative pressure forming port 161b may be formed in the drawer body 161. One side of the negative pressure forming port 161b is connected to a wastewater pumping flow path part 178, and the other side may be connected to a negative pressure forming port 179d of the wastewater tank 179. Accordingly, when a wastewater pump is operated, air can pass through the negative pressure forming port 179d.

Further, a wastewater inlet port 161c may be formed in the drawer body 161. One side of the wastewater inlet port 161c is connected to a wastewater flow path part 177, and the other side may be connected to a wastewater inlet port 179f of the wastewater tank 179. Accordingly, when the wastewater pump is operated, wastewater can pass through the wastewater inlet port 179f.

Meanwhile, the port may be disposed at an upper side in a direction of gravity than the lower surface of the liquid tank accommodation part. Through this, it is possible to discharge fresh water to the washing water flow path part 173 by gravity regardless of the operation of the pump, or to prevent wastewater from flowing backward.

Meanwhile, a leakage discharge port 161e may be formed on the lower surface of the drawer body 161. A drainage flow path part 172 may be connected to the leakage discharge port 161e. Through this, liquid that has flowed out from the liquid tanks 171, 179 can be discharged to the washing tub 128 through the leakage discharge port 161e. Accordingly, it is possible to prevent the liquid that has flowed out from the liquid tanks 171, 179 from contaminating the inside of the robot cleaner station 100.

Meanwhile, an inclined surface 161f may be formed on the lower surface of the drawer body 161. The inclined surface 161f may be formed to be inclined downward toward the leakage discharge port 161e. Accordingly, liquid that has flowed out from the liquid tanks 171, 179 can be guided by the inclined surface 161f and discharged to the leakage discharge port 161e.

Meanwhile, the rails 162 are provided on the drawer body 161 and can guide the extraction of the drawer body 161. Specifically, a pair of rails 162 may be provided on lateral surfaces of the drawer body 161 in the lateral direction. The rails 162 are coupled with rails (not shown) formed on the inner surface of the housing 110 to guide the front-rear movement of the drawer body 161.

The drawer cover 163 may form the front appearance of the drawer body 161. The drawer cover 163 may form the front surface of the housing 110. The drawer cover 163 may be disposed at the upper side of the storage unit cover 145.

The drawer cover 163 may be formed to have a width larger than the maximum diameter of the drawer body 161. Further, the drawer cover 163 may be formed to have a height larger than the maximum height of the drawer body 161. Accordingly, in a state where the drawer 160 is inserted into the housing 110, the drawer cover 163 covers the front of the drawer body 161 to block the inside of the drawer body 161 from being exposed.

Meanwhile, a grip part 163a may be formed in the drawer cover 163. The grip part 163a may be provided so as to be grippable by a user. For example, the grip part 163a may be formed to be recessed from an upper end of a rear surface of the drawer cover 163. That is, a recessed part into which a user's hand can enter may be formed at the upper end of the rear surface of the drawer cover 163.

Accordingly, the user can put a hand into the grip part 163a and pull the drawer 160 to extract the drawer 160.

Meanwhile, the washing water tank 171 and the wastewater tank 179, which have relatively heavy weights within the robot cleaner station 100, may be accommodated in the drawer 160. Accordingly, as an extraction distance of the washing water tank 171 and the wastewater tank 179 becomes longer, the overall center of gravity of the robot cleaner station 100 moves to the outside of the robot cleaner station 100, and the robot cleaner station 100 may tip over.

In order to solve this, in the present disclosure, the maximum extraction distance of the drawer 160 may be half or less of a front-rear length of the housing 110. In this case, the center of gravity may remain inside the housing 110 by the weights of the relatively heavy dust collection motor 153 and pumps.

Therefore, according to the present disclosure, even if the drawer 160 is extracted, it is possible to prevent the robot cleaner station 100 from tipping over.

### Docking Sensor Unit

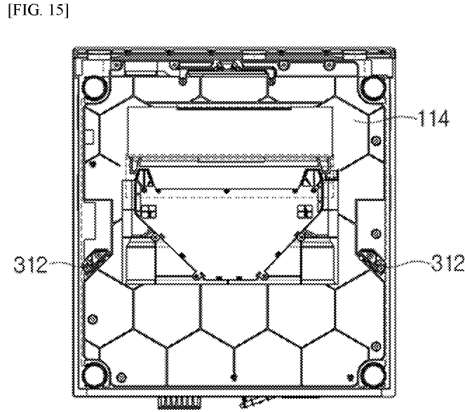

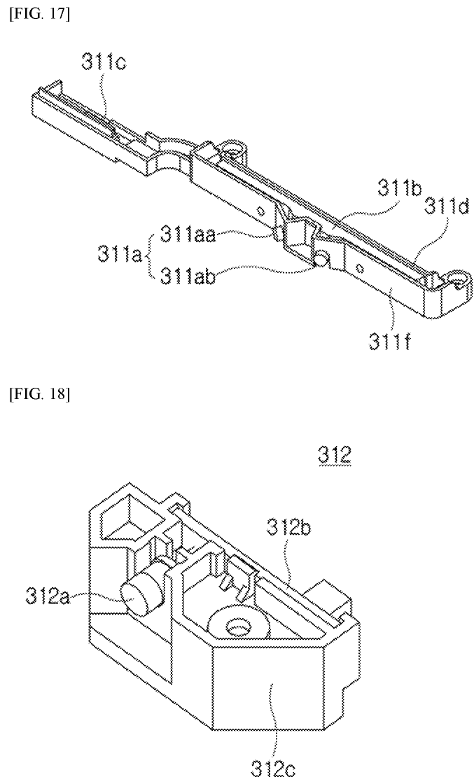

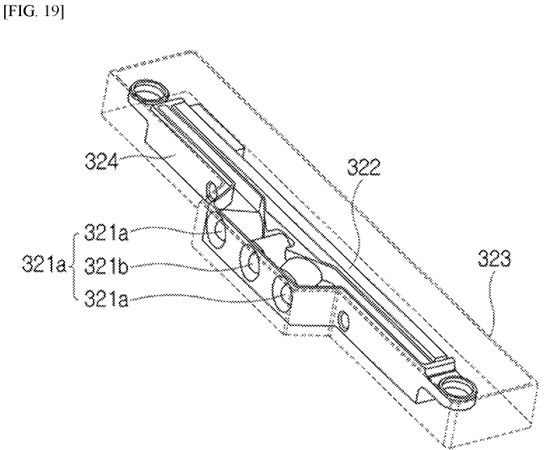

FIG. 15 is a bottom view of FIGS. 1 and 6 is a view for explaining a docking sensor unit of a robot cleaner station according to an embodiment of the present disclosure, FIG. 17 is a perspective view of a first front sensor according to an embodiment of the present disclosure, FIG. 18 is a perspective view of a first side sensor according to an embodiment of the present disclosure, and FIG. 19 is a perspective view of a second sensor according to an embodiment of the present disclosure.

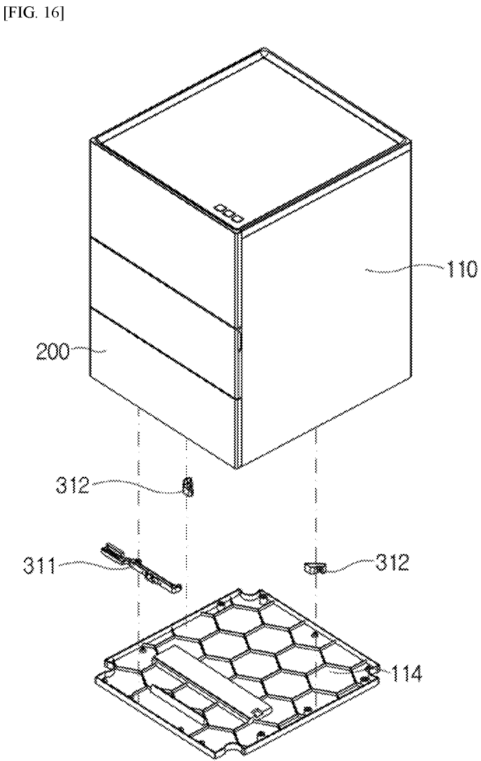

The docking sensor unit according to the embodiment of the present disclosure will be described with reference to FIGS. 15 to 19 as follows.

The docking sensor unit 300 is installed in the robot cleaner station 100 and can monitor a position of the robot cleaner 200. The docking sensor unit 300 receives a signal from the robot cleaner 200, and when a distance between the position of the robot cleaner 200 and the robot cleaner station 100 is smaller than a preset distance, a control unit (not shown) can control the door unit 130 to be opened.

Accordingly, by reducing a waiting time for the door unit 130 to open, the robot cleaner 200 can move into the inside of the robot cleaner station 100 immediately after aligning its position at the front of the robot cleaner station 100.

Further, the docking sensor unit 300 transmits and receives signals to and from the robot cleaner 200 to guide the robot cleaner 200 to be seated on the seating part 120 through the entrance 127. Further, the docking sensor unit 300 can align a pair of wheels of the robot cleaner 200 to be positioned on an extension line of the auxiliary approach path 131b.

For example, the docking sensor unit 300 may be an infrared sensor, but is not limited thereto.

The docking sensor unit 300 may include a first sensor 310 and a second sensor 320, and the first sensor 310 may include a first front sensor 311 and a first side sensor 312.

The first sensor 310 may be positioned closer to the ground than the second sensor 320. More specifically, the first sensor 310 may be positioned between the lower surface 114 of the housing 110 and the base 121.

The first sensor 310 may be fixedly coupled to the lower surface 114 of the housing 110 and may contact the front surface 111 or a side surface of the housing 110. Accordingly, in a state where the door unit 130 is closed, the first sensor 310 may be exposed and can smoothly transmit and receive signals to and from the robot cleaner 200 positioned around the robot cleaner station 100.

The first sensor 310 includes the first front sensor 311 and the first side sensor 312.

The first front sensor 311 is positioned at the lower side of the base 121 and may be positioned at a front end of the lower surface 114 of the housing 110. More specifically, the first front sensor 311 may be positioned more forward than the legs 115. Further, if the legs 115 are disposed at corners of the lower surface 114, the first front sensor 311 may be positioned between a pair of legs 115 positioned at the front.

The first front sensor 311 may include a sensing part 311a, a printed circuit board 311b, an LED module 311c, a gasket 311d, a transmission window 311e, and a fixing case 311f.

The sensing part 311a, the printed circuit board 311b, and the LED module 311c may be coupled and fixed to the fixing case 311f. Further, the fixing case 311f may be fixed to the lower surface 114 of the housing 110.

The fixing case 311f is formed to extend long in the lateral direction as a whole, and may include a coupling space formed to correspond to outer circumferential surfaces of the sensing part 311a, the printed circuit board 311b, and the LED module 311c.

For example, a circular space to which the circular sensing part 311a is coupled is provided on the front of the fixing case 311f, a rectangular space into which the printed circuit board 311b is inserted is provided at the rear of the circular space, and a rectangular insertion groove into which the LED module 311c is inserted may be provided at one side of the rectangular space.

Further, the fixing case 311f may include a bolt coupling groove so as to be bolt-coupled to the lower surface 114, and at least one bolt coupling groove may be provided.

The sensing part 311a may include a receiving part 311aa and a transmitting part 311ab, and may be electrically connected to the printed circuit board 311b.

For example, the transmitting part 311aa can emit a signal to the robot cleaner 200 in a beacon manner, and can transmit information on a direction and a distance that the robot cleaner 200 should move by transferring a specific signal pattern in a specific direction.

Further, the receiving part 311ab receives a signal transmitted from the robot cleaner 200, converts it into a pulse width modulation or a digital signal, and can receive position and state information of the robot cleaner by measuring the intensity of the signal.

The printed circuit board 311b is disposed at the rear of the sensing part 311a and may be formed in a rectangular shape in which a lateral length is longer than a vertical length.

The printed circuit board 311b controls the transmitting part 311ab to emit a signal with an accurate pattern and intensity, filters the signal received by the receiving part 311aa, decodes and converts data, and can transfer it to the control unit (not shown) of the robot cleaner station 100.

The LED module 311c is disposed at one side of the printed circuit board 311b and may include a reflector 311ca.

The LED module 311c may be electrically connected to the transmitting part 311aa. At this time, the LED module 311c and the transmitting part 311aa may be connected in a wired manner using a wire or a connector, or connected in a wireless manner such as Wi-Fi or Bluetooth.

The LED module 311c can emit light to transmit and receive signals to and from the robot cleaner 200, and by providing the reflector 311ca, a signal transmission/reception range with the robot cleaner 200 can be expanded or reliability can be increased.

The gasket 311d may be formed to cover the outer circumferential surface of the printed circuit board 311b. Accordingly, it is possible to prevent electromagnetic interference of the printed circuit board 311b and protect internal components by alleviating a physical external impact.

For example, the gasket 311d is formed of a metallic material such as conductive silicone or conductive foam to prevent the sensor from malfunctioning due to static electricity.

The first side sensor 312 is positioned more rearward than the first front sensor 311 and may be positioned at lateral ends of the lower surface 114 of the housing 110. More specifically, if the legs 115 are disposed at the corners of the lower surface 114, the first side sensor 312 may be positioned between a pair of legs 115 positioned at the front and rear.

At least one first side sensor 312 may be provided on the lower surface 114 of the housing 110. For example, two first side sensors 312 may be provided at the lateral ends.

Accordingly, the first side sensor 312 senses the position of the robot cleaner 200 and can serve as an auxiliary sensor to prevent the robot cleaner 200 from colliding with the robot cleaner station 100.

Similar to the first front sensor, the first side sensor 312 may also include a sensing part 312a, a printed circuit board 312b, and a fixing case 312c.

The sensing part 312a can transfer a signal to the robot cleaner 200 in a beacon manner or sense a signal reflected from the robot cleaner 200 to prevent the robot cleaner 200 from colliding with the robot cleaner station 100.

Further, a longitudinal axis of the sensing part 312a may be disposed to intersect a line parallel to the ground connecting the front and rear of the robot cleaner station 100. That is, based on viewed from a side front of the robot cleaner station 100, the sensing part 312a may be disposed to be inclined to the left or the right.

The robot cleaner station 100 is often disposed such that the rear surface faces a wall. Accordingly, by the arrangement as described above, the first side sensor 312 can transmit a signal to a wider range at the front.

The fixing case 312c is coupled with the sensing part 312a and the printed circuit board 312b to fix the sensing part 312a and the printed circuit board 312b, and the fixing case 312c includes a bolt insertion groove into which a bolt is inserted so as to be coupled to the lower surface 114 of the housing 110.

Meanwhile, the robot cleaner 200 can selectively change a sensor that transmits and receives signals. More specifically, according to the position of the robot cleaner 200, the sensor that transmits and receives signals to and from the robot cleaner 200 may be changed to the first front sensor 311 or the first side sensor 312.

For example, when the robot cleaner 200 travels from the rear toward the front based on the entrance 127 of the robot cleaner station 100, if the robot cleaner 200 is positioned more rearward than the entrance 127, the robot cleaner can travel forward by transmitting and receiving signals to and from the first side sensor 312.

When the robot cleaner 200 travels forward and is positioned more forward than the entrance 127, the robot cleaner 200 can travel to a position where the robot cleaner 200 can dock with the robot cleaner station 100 by transmitting and receiving signals to and from the first front sensor 311.

That is, when the robot cleaner 200 moves from the rear toward the front based on the entrance 127, the sensor that transmits and receives signals to and from the robot cleaner 200 may be changed from the first side sensor 312 to the first front sensor 311.

Accordingly, the first side sensor 312 can prevent the robot cleaner 200 from colliding with the robot cleaner station 100 and guide it to the front of the robot cleaner station 100.

As a method for changing the sensor that transmits and receives signals, a distance-based switching method, an image analysis-based switching method, and a space mapping-based change method may be used.

For example, the method for changing the sensor that transmits and receives signals to and from the robot cleaner 200 from the first side sensor 312 to the first front sensor 311 may be changed by activating a sensor having the strongest signal intensity sensed by each sensor, or by utilizing data such as sensed distance or image data.

The second sensor 320 according to the embodiment of the present disclosure will be described with reference to FIG. 19. The second sensor may have a structure similar to the first front sensor. However, in order to avoid repeated description, the configuration and effect of the first front sensor may be cited, and the additional configuration of the second sensor will be mainly described as follows.

The second sensor 320 is installed on the door frame 132 to recognize the approach of the robot cleaner 200 and can align the robot cleaner 200 to a position for docking with the robot cleaner station 100.

The second sensor 320 may be positioned at an upper portion on a rear surface of the door frame 132. Through this, a sensing range can be maximized. Further, the second sensor 320 may be installed at a lateral center portion of the entrance 127. Through this, an entry direction of the robot cleaner 200 can be guided through communication with the robot cleaner.

More specifically, a sensing part 321 of the second sensor 320 may be disposed between a one-third point and a two-thirds point of a lateral width of the robot cleaner station 100. Further, the second sensor 320 may be positioned on the same plane perpendicular to the ground as the first front sensor 311.

The second sensor 320 may include one transmitting part 321b and two receiving parts 321a disposed on both sides of the transmitting part 321b. Accordingly, the second sensor 320 can sense a relatively wider area and receive an accurate position signal.

Accordingly, when the robot cleaner 200 attempts to dock with the robot cleaner station 100, the second sensor 320 can adjust it to a more detailed and accurate position to prevent the occurrence of a docking error.

A transmission window 323 may be provided on an outer circumferential surface of the second sensor 320. The transmission window 323 is formed to correspond to an outer circumferential surface of a fixing case 324 and can cover the fixing case 324.

The transmission window 323 may be formed of a material through which a signal of the sensor can be transmitted. For example, the transmission window 323 may be formed of a material such as silicone, zinc selenide, or germanium.

Meanwhile, the robot cleaner 200 can selectively change the sensor that transmits and receives signals. More specifically, according to the opening of the door unit 130, the sensor that transmits and receives signals to and from the robot cleaner 200 may be changed to the first front sensor 311 or the second sensor 320.

For example, in a state where the door unit 130 is closed, when the robot cleaner 200 is positioned at the front of the door unit 130, the robot cleaner 200 can align with a position to be docked with the robot cleaner station 100 by transmitting and receiving signals to and from the first front sensor 311.

That is, the first front sensor 311 may be exposed to the outside in the state where the door unit 130 is closed, and the robot cleaner 200 is spaced apart by the first front sensor 311 to a distance at which the door unit 130 is opened to contact the ground, and can align such that the pair of wheels are positioned on the extension line of the auxiliary approach path 131b.

Thereafter, in a state where the door unit 130 is opened, the robot cleaner 200 transmits and receives signals to and from the second sensor 320, and can be seated inside the robot cleaner station 100 through the auxiliary approach path 131b.

That is, the second sensor 320 may be exposed in the state where the door unit 130 is opened, and when the door unit 130 is opened, the sensor that transmits and receives signals to and from the robot cleaner 200 may be changed from the first front sensor 311 to the second sensor 320.

Signal transmission with the first front sensor 311 may be physically restricted by the opening of the door unit 130, which may cause a docking error. Accordingly, it is possible to prevent the docking error from occurring by changing the sensor communicating with the robot cleaner 200 from the first front sensor 311 to the second sensor 320 as described above.

Further, since the second sensor 320 is not exposed to the outside when the door unit 130 is closed, the robot cleaner station 100 according to the embodiment of the present disclosure can provide a user with an aesthetic appearance as indoor furniture.

Meanwhile, as a method for changing the sensor that transmits and receives signals, a distance-based switching method, an image analysis-based switching method, and a space mapping-based change method may be used.

For example, the method for changing the sensor that transmits and receives signals to and from the robot cleaner 200 from the first front sensor 311 to the second sensor 320 may be changed by activating a sensor having the strongest signal intensity sensed by each sensor, or by utilizing data such as sensed distance or image data.

The docking sensor unit 300 may further include a voice recognition module (not shown) capable of recognizing a sound produced by the user or the robot cleaner 200.

The voice recognition module (not shown) may be mounted at one side of the first front sensor 311 and the second sensor 320. Accordingly, when the door unit 130 is opened, the voice recognition module (not shown) provided in the second sensor 320 may be activated, and when the door unit 130 is closed, the voice recognition module (not shown) provided in the first front sensor 311 may be activated.

The voice recognition module (not shown) includes a microphone to recognize a sound produced by the user or the robot cleaner 200, converts it into an electrical signal, and can transfer it to the control unit (not shown).

That is, the user can control functions that the robot cleaner station 100 can perform by the user's voice. For example, the user can execute control such as cleaning start or end by voice. The user can operate the robot cleaner station 100 by speaking a command for controlling an operation of the robot cleaner station 100 by voice.

Although the present disclosure has been described in detail through specific embodiments, this is for describing the present disclosure in detail, and the present disclosure is not limited thereto. It is obvious that modifications or improvements can be made by those skilled in the art within the technical spirit of the present disclosure.

All simple modifications or changes of the present disclosure fall within the scope of the present disclosure, and the specific protection scope of the present disclosure will be clarified by the appended claims.

### DESCRIPTION OF REFERENCE NUMERALS

100: Robot cleaner station

200: Robot cleaner

300: Docking sensor unit

310: First sensor

311: First front sensor

311a: Sensing part

311aa: Receiving part

311ab: Transmitting part

311b: Printed circuit board (PCB)

311c: LED module

311ca; Reflector

311d: Gasket

311f: Fixing case

312: First side sensor

312a: Sensing part

312b: Printed circuit board (PCB)

312c: Fixing case

320: Second sensor

321: Sensing part

321a: Receiving part

321b: Transmitting part

322: Printed circuit board (PCB)

323: Transmission window

324: Fixing case

What is claimed is:

1. A robot cleaner station, comprising:
a housing;
a base disposed in the housing, wherein at least a portion of a robot cleaner is seated on the base;
a door unit configured to open and close an entrance through which the robot cleaner enters and exits the base; and
a docking sensor unit configured to transmit and receive a signal to and from the robot cleaner,
wherein the docking sensor unit comprises a first sensor and a second sensor, and
wherein the first sensor is operated in a state where the door unit is closed, and the second sensor is operated in a state where the door unit is opened.

2. The robot cleaner station of claim 1, wherein the first sensor is positioned closer to the ground than the second sensor.

3. The robot cleaner station of claim 1, wherein the first sensor is coupled to a lower surface of the housing.

4. The robot cleaner station of claim 1, wherein the second sensor is positioned at an upper side of a bottom surface of the housing.

5. The robot cleaner station of claim 1, wherein the first sensor is exposed in the state where the door unit is closed.

6. The robot cleaner station of claim 1, wherein the second sensor is exposed in the state where the door unit is opened.

7. The robot cleaner station of claim 1, wherein the first sensor includes a first front sensor and a first side sensor, and
wherein a sensor transmitting and receiving the signal to and from the robot cleaner is selectively switched between the first front sensor and the first side sensor according to a position of the robot cleaner.

8. The robot cleaner station of claim 7, wherein the first front sensor is positioned at a lower side of the entrance and positioned at a front end of a bottom surface of the housing.

9. The robot cleaner station of claim 7, wherein the first side sensor is positioned more rearward than the first front sensor and positioned at lateral ends of the housing.

10. The robot cleaner station of claim 1, wherein the docking sensor unit further includes a voice recognition module.
